(19) United States
(12) Patent Application Publication
(10) Pub. No.: US 2005/0284499 A1
(43) Pub. Date: Dec. 29, 2005

(54) Disposable toothbrush having integral toothpaste reservoir

(76) Inventor: Quentin J. Fleming, Everett, WA (US)

Correspondence Address: TODD N. HATHAWAY, 119 N. COMMERCIAL ST. #620, BELLINGHAM, WA, 98225, US

(21) Appl. No.: 10/876,986

(22) Filed: Jun. 25, 2004

(51) Int. Cl. A46B 15/00; B43K 5/06; A46B 11/00

(52) U.S. Cl. 132/311

(57) ABSTRACT

A single-use disposable toothbrush assembly having an integral supply of toothpaste that is discharged into the bristles in response to the toothbrush head being pressed onto the handle of the assembly. The head includes a plurality of bristles and an internal chamber that contains a supply of toothpaste. A shaft portion of the handle is received in the chamber in sliding engagement therewith, so that in response to the handle member being pushed towards the head member an end of the shaft portion moves through the chamber so as to force the toothpaste out through at least one opening and into the bristles. The internal chamber of the head member is charged with a supply of toothpaste before the head is installed on the handle member and the assembly packaged for subsequent use.

### BACKGROUND OF THE INVENTION

a. Field of the Invention

The present invention relates generally to toothbrushes and oral hygiene, and more particularly, to a disposable, single-use toothbrush having an integral reservoir for holding a supply of toothpaste.

b. Related Art

Disposable toiletry items offer great convenience to travelers and others needing to carry their personal necessities. For example, many motels and hotels commonly provide disposable, single-use supplies of shampoo, soap, hand lotion or other such items, for the convenience of their guests. Other instances where disposable toiletries offer significant advantages include airline travel, military field duty and camping, among many others.

Although the toiletry articles listed above have long been available in the art, toothpaste and toothbrushes have heretofore presented certain obstacles to being provided in single-use, disposable form. Even though they are intended to be used together, toothbrushes and toothpaste are ordinarily supplied as separate articles, which means a doubling of packaging and handling costs, which runs counter to the convenience and low cost that are essential to a single-use, disposable product. Furthermore, only a small amount of toothpaste is required for personal, one time use, to the point where providing individual packaging for such small amounts is not economical, and the packaging is so small that it becomes difficult and inconvenient to open and dispense onto the toothbrush.

A variety of devices have been proposed for providing a toothbrush with an integral supply of toothpaste. In most instances, these efforts have taken the form of providing a reservoir for the toothpaste that is located in handle of the structure, usually so that the toothpaste is dispensed as the handle is squeezed by the user. In general, such prior devices are too complex and costly to be manufactured for one-time, disposable use. Likewise, the configuration of most of the prior devices requires them to be filled or refilled by the user, and they are not suitable for being filled with a small amount of toothpaste in a high-speed manufacturing process. Moreover, most of the prior devices employ an elongate passage or conduit to convey the toothpaste from the handle to the brush head of the assembly, which is not only difficult to manufacture economically, but also tends to lead to hardening and clogging of the toothpaste if the assembly is left in storage for an extended period, as can be expected with a disposable product.

Accordingly, there exists a need for a single use, disposable toothbrush assembly having an integral supply of toothpaste, so as to obviate the need for separate packaging and handling of the brush and toothpaste. Furthermore, there exists a need for such a toothbrush assembly that is inexpensive to manufacture and that can be readily provided with a suitable sized supply of toothpaste in a high speed manufacturing process. Still further, there exists a need for such a toothbrush assembly that is simple and convenient to use. Still further, there exists a need for such a toothbrush assembly that will continue to function reliably after long periods of storage while containing the supply of toothpaste therein.

### SUMMARY OF THE INVENTION

The present invention has solved the problems cited above, and is a single use, disposable toothbrush assembly having an integral supply of toothpaste.

Broadly, this comprises (i) a head member, comprising a plurality of bristles mounted at an exterior of the head member, an internal chamber for holding a supply of toothpaste, and at least one opening for permitting discharge of the toothpaste from the reservoir to the bristles, and (ii) a handle member, comprising a shaft portion which is received for sliding movement in the chamber of the head member, so that the end of the shaft member moves through the reservoir so as to force the toothpaste out through the discharge opening in response to the head member being pressed longitudinally onto the shaft member.

The reservoir chamber in the head member may be configured to receive the shaft portion of the handle member in sliding engagement therewith. The reservoir chamber may have an opening at one end for receiving the end of the shaft portion therein. The at least one discharge opening may comprise a plurality of ports formed within an area of bristles mounted on the head member.

Means may be provided for preventing the shaft portion from being withdrawn from the chamber in the head member once the toothpaste has been discharged therefrom. The means for retaining the shaft portion in the chamber may comprise an outwardly projecting tooth member formed on the shaft portion and a cooperating recess formed on the interior of the chamber for receiving the tooth member in locking engagement therewith.

The shaft portion of the handle member may be configured to prevent the head member from rotating thereon. The shaft portion may have a rectangular cross section and the interior of the reservoir chamber may have a corresponding rectangular configuration for engaging the shaft portion so as to hold the head member against rotation thereon.

The toothbrush assembly may be formed of injection molded plastic. The material forming the head member may have a predetermined degree of resilient flexibility so as to permit the locking tooth on the shaft portion to enter the open end thereof.

These and other features and advantages of the present invention will be apparent from a reading of the following detailed description with reference to the accompanying drawings.

### BRIEF DESCRIPTION OF THE DRAWINGS

FIG. 1 is a perspective view of a toothbrush assembly in accordance with the present invention, showing the brush head which contains the supply of toothpaste and which is slidably mounted to the outer end of the handle portion for selectively forcing the toothpaste out of the reservoir and into the bristles;

FIG. 2 is an elevational view of the toothbrush assembly of FIG. 1, showing the manner in which this is suitably packaged in a plastic wrapper for storage and distribution prior to use;

FIG. 3 is an enlarged, elevational view of the forward end of the brush assembly of FIGS. 1-2, showing the brush head in its initial, extended position and the manner in which the supply of toothpaste is contained within a reservoir in the brush head of the assembly; and

FIG. 4 is an elevational view of the forward end of the brush assembly of FIGS. 1-2, similar to FIG. 3, showing the manner in which the brush head is slid rearwardly on the shaft of the handle portion so that the head end of the shaft forces the toothpaste out of the reservoir and into the bristles on the brush head of the assembly.

### DETAILED DESCRIPTION

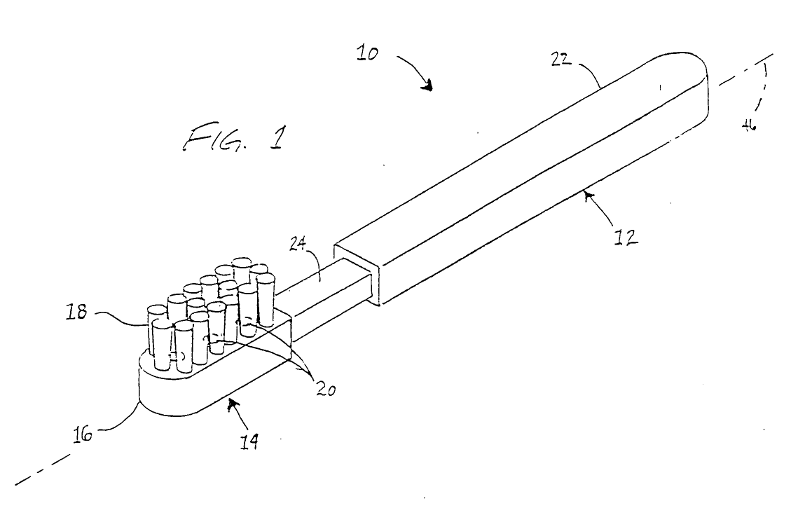

FIG. 1 shows a single use, disposable toothbrush assembly 10 in accordance with the present invention. As can be seen, the assembly includes two primary components, i.e., a handle member 12 and a head member 14. The head member is formed by an elongate housing 16 having a plurality of bristles 18 mounted on one side, giving an external configuration somewhat similar to that of the bristle portion of a conventional toothbrush.

As will be described in greater detail below, the housing of the head member is hollow, so as to provide the reservoir for containing a supply of toothpaste therein. A plurality of ports 20 or similar openings provide fluid communication between the internal chamber and the exterior of the housing, so that toothpaste is discharged through the ports from the chamber into bristles 18.

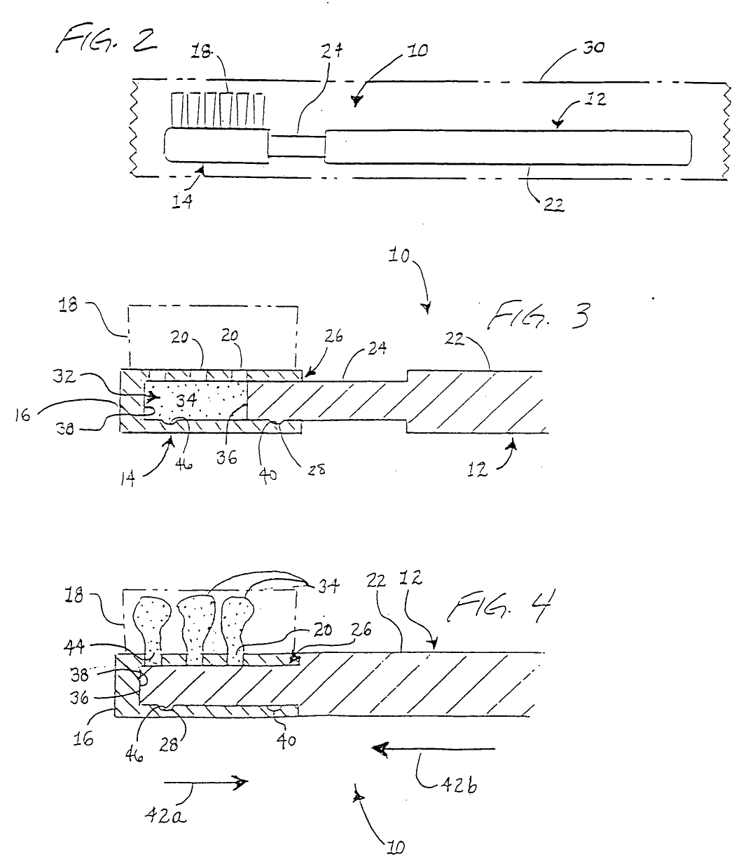

The handle member 12, in turn, includes a grip portion 22, which may be of any suitable configuration for being held in a user's hand. An elongate shaft portion 24 extends from the forward end of the handle member and extends into an open end 26 (see FIG. 3) of the housing of the head member 14 in close fitting, sliding engagement therewith. As will be described in greater detail below, the head end of the shaft portion interfits with the walls of the reservoir within the head member in a manner of a piston or ram, for forcing toothpaste out of the reservoir in response to sliding movement therethrough. A locking tooth 28 is formed on the exterior of the handle shaft 24 for preventing the shaft from sliding back out of the head member, as will also be described in greater detail below.

As can be seen in FIG. 2, the toothbrush assembly 10 of the present invention thus provides a compact unit which contains its own supply of toothpaste and which is easily packaged on a single unit basis, for example, using a disposable plastic wrapper 30. The wrapper 30 may also be used to display advertising, instructions, or other information as desired.

Having provided an overview of the invention, the structure and operation of its components will now be described in greater detail.

FIG. 3 shows the toothbrush assembly 10 in its initial configuration, as supplied ready for use as shown in FIG. 2, for example. As can be seen, the reservoir chamber 32 is formed within the head member and holds the supply of toothpaste 34, with the amount of toothpaste being sufficient for a single use. The chamber is somewhat elongate and open at one end 26, with the forward end 36 of the handle shaft 24 being received therein in a sliding engagement. As was noted above, the ports 20 are formed on the same side of the housing as the bristles 18, for permitting the passage of the toothpaste therethrough; the ports may be of any suitable configuration and in some embodiments there may be a single opening, however, it is generally preferred to have a plurality of ports arranged longitudinally with respect to the axis of the shaft and chamber, so as to achieve more or less even distribution of the toothpaste within the bristles. Although not shown in FIG. 3, a rupturable or slit diaphragm, a sealant layer or other form of seal or temporary closure may in some embodiments be formed or disposed over the supply of toothpaste where this is exposed at the ports 20 or other openings, so as to help prevent the toothpaste from drying out or hardening during extended storage.

Overall, the head member is preferably similar in size and shape to the corresponding portion of a conventional toothbrush so that the assembly can be employed by a user in a convenient manner. For example, the housing 16 may suitably have external dimensions as follows: length—approx. 1 to 1½ inches; width—approx. ⅜ to ½ inch; depth—approx. ¼ to ½ inch. The last dimension (depth) is somewhat greater than the head of a conventional toothbrush, so as to provide capacity for the change of toothbrush while still allowing a wall thickness adequate for satisfying anchoring of the bristles. It will be understood, however, that other suitable dimensions may be used, depending on the size of the reservoir and other design factors.

The handle shaft 24 is sized and shaped to fit tightly within the reservoir chamber 34 while still permitting longitudinal movement therethrough, in a manner similar to a piston fitting within a cylinder. In a preferred embodiment, the housing 16 may be formed of a resilient, slightly yielding material and the chamber cross section may be sized very close to or even slightly smaller than that of the shaft 24, so as to form an effective seal that prevents the escape of toothpaste through opening 26 without requiring an O-ring or other dedicated seal member. In a preferred embodiment, the shaft and chamber are square or rectangular in cross-section so as to prevent the head member from twisting and rotating relative to the handle member during use; in other embodiments other non-circular cross-sections (e.g., triangular or oval) may be used to accomplish this purpose, or there may be a keyway or other structure for permitting the sliding movement while preventing rotation of the head member on shaft 24.

The sides of the handle shaft 24 are also preferably configured to engage the inside walls of the reservoir chamber 32, so as to maintain lateral rigidity of the assembly and prevent the head member from wobbling or rocking back and forth on the end of the shaft during use.

As can be seen in FIG. 1 and also FIG. 2, the elongate structural components of the assembly—the grip portion 22, the shaft portion 24 and the housing 16—are all preferable aligned along a substantially common lengthwise axis 46. This relationship helps ensure that the opposing forces are aligned coaxially as the ends of the assembly are pressed together, so that the assembly compresses in a smooth and efficient manner and any tendency to bind or cock to one side (as might result from components having an offset relationship) is eliminated.

To use the assembly, it is removed from its packaging and the head and handle members are pressed together in the direction indicated by arrows 42a and 42b in FIG. 4. As this is done, the locking tooth 28 on the shaft is displaced from its initial notch or socket 40 near opening 26, and the forward end 36 of the handle shaft 24 moves longitudinally through reservoir 32 in the manner of a ram or piston, forcing the toothpaste 34 outwardly through ports 20, in the direction indicated by arrows 44. As it is discharged, the toothpaste becomes embedded and held in the bristle area 18, where it is ready for use in brushing the person's teeth in a normal manner. As the handle shaft 24 reaches the end of its travel through the reservoir, the locking tooth 28 enters a second notch 46 near the closed end 38 of the chamber. The locking tooth 28 thus engages the second notch 46 so as to prevent the shaft from being withdrawn from the housing, while the abutment of surfaces 36 and 38 prevents movement in the opposite direction. The head member is thus held firmly on the end of the handle member, and does not slide or shift about as the assembly is being used. The housing 16 is preferably formed of a material having a degree of resilient flexibility so as to temporarily deform in order to permit passage of the tooth within the chamber, and the tooth 28 itself is preferably rounded or beveled so as to facilitate its movement in the inward direction. It will also be understood that the locations of the tooth and notches may be reversed, and that other forms of locking mechanisms may be used as well.

The assembly is discarded after brushing is complete.

The assembly of the present invention may be manufactured of any suitable material, although injection molded plastic is generally preferred as providing a satisfactory combination of low cost and adequate strength. The bristles may be attached by molding the material of the head member about them, in a manner somewhat similar to that of conventional toothbrushes. The head members can then be very rapidly and efficiently filled by injecting a predetermined amount of toothpaste into the reservoir chamber 32 before installing the handle member.

It is to be recognized that various alterations, modifications, and/or additions may be introduced into the constructions and arrangements of parts described above and the claims below without departing from the spirit or ambit of the present invention.

1. A single-use, disposable toothbrush assembly having an integral supply of toothpaste, said toothbrush assembly comprising:
a head member, comprising:
a housing;
a plurality of bristles mounted at an exterior of said housing;
a chamber formed within said housing;
a supply of toothpaste contained within said chamber; and
at least one opening formed in said housing for permitting discharge of toothpaste from said chamber into said bristles on said exterior of said housing; and
a handle member, comprising:
a grip portion for being held in a user's hand; and
a shaft portion having an end which is received for sliding movement in said chamber of said head member;
so that in response to said handle member being pushed towards said head member, said end of said shaft portion moves through said chamber so as to force said toothpaste out through said at least one opening and into said bristles.

2. The toothbrush assembly of claim 1, wherein said chamber in said head member comprises:
a longitudinally extending chamber having an opening at one end in which said shaft of said handle member is received for longitudinal sliding movement through said chamber.

3. The disposable toothbrush assembly of claim 2, wherein said at least one opening comprises:
a plurality of ports spaced lengthwise along said longitudinally extending chamber, for distributing said toothpaste into said bristles on said exterior of said head member.

4. The disposable toothbrush assembly of claim 2, wherein said shaft portion of said handle member comprises:
a longitudinally extending end portion having a transverse cross-section that substantially matches a transverse cross-section of said chamber, so that said chamber forms a close-fitting engagement with said end portion of said shaft portion that stabilizes said head member on said handle member during use of said assembly.

5. The disposable toothbrush assembly of claim 4, wherein said chamber and said end portion of said shaft portion of said handle member each have non-circular transverse cross-sections so that said chamber and end portion cooperate so as to prevent said head member from rotating on said handle member during use of said assembly.

6. The disposable toothbrush assembly claim 5, wherein said chamber and said end portion of said shaft portion of said handle member each have substantially rectangular cross-sections.

7. The disposable toothbrush assembly of claim 4, further comprising:
means for preventing said shaft portion of said handle member from being withdrawn from said chamber after said toothpaste has been discharged therefrom.

8. The disposable toothbrush assembly of claim 7, wherein said means for preventing said shaft portion from being withdrawn from said chamber comprises:
a first locking feature formed on said shaft portions of said handle member, and a second locking feature formed in said chamber of said handle member that engages said first locking feature when said shaft portion reaches a fully inserted position in said chamber.

9. The disposable toothbrush assembly of claim 8, wherein said first locking feature comprises a protruding tooth formed on said shaft portion and said second locking feature comprises a recess formed in said chamber for receiving said protruding tooth therein.

10. The disposable toothbrush of claim 9, further comprising:
a second recess formed in said chamber for receiving said protruding tooth when said shaft portion is in a retracted position in said chamber, so as to retain said head member on said handle member prior to use of said assembly.

11. The disposable toothbrush of claim 4, further comprising:
means for retaining said head member on said handle member prior to use of said assembly.

12. The disposable toothbrush assembly of claim 4, wherein said grip portion of said handle member extends generally along a lengthwise axis of said assembly and said shaft portion of said handle member extends from a first end of said grip portion in substantially coaxial relationship.

13. The disposable toothbrush assembly of claim 12, wherein said housing of said head member comprises:
a closed-ended sleeve that defines said chamber and that extends in substantially coaxial relationship with said grip and shaft portions of said handle member.

14. A single-use, disposable toothbrush assembly for being filled with an integral supply of toothpaste, said toothbrush assembly comprising:
a head member, comprising:
a housing;
a plurality of bristles mounted at an exterior of said housing;
a chamber formed within said housing for being filled with said supply of toothpaste; and
at least one opening formed in said housing for permitting discharge of toothpaste from said chamber into said bristles on said exterior of said housing; and
a handle member, comprising:
a grip portion for being held in a user's hand; and
a shaft portion having an end for being received for sliding movement in said chamber of said head member;
so that in response to said handle member being pushed towards said head member, said end of said shaft portion will move through said chamber so as to forced toothpaste from a supply in said chamber out through said at least one opening and into said bristles.
